(19) United States
(12) Patent Application Publication
(10) Pub. No.: US 2013/0052603 A1
(43) Pub. Date: Feb. 28, 2013

(54) PALATE FIXTURE FOR ORTHODONTICS

(71) Applicant: Jang Hoon Ahn, Seoul (KR)

(72) Inventor: Jang Hoon Ahn, Seoul (KR)

(21) Appl. No.: 13/695,292

(22) PCT Filed: Apr. 19, 2011
(86) PCT No.: PCT/KR2011/002770

§ 371 Date: Oct. 30, 2012

(30) Foreign Application Priority Data
Apr. 30, 2010 (KR) 10-2010-0040904

(51) Int. Cl. A61C 7/10

(52) U.S. Cl. 433/7

(57) ABSTRACT

A palate fixture includes: a base portion including at least four sides, a palate surface and an oral inner surface; a pair of fixing pieces, each fixing piece extending from a side of the base portion that is opposite the other, and offset from the base portion; and a pair of ring pieces, each ring piece extending from a side of the base portion that is opposite the other, and sloped toward the oral inner surface.

### TECHNICAL FIELD

Embodiments relate to a palate fixture for orthodontics, and more particularly, to an orthodontic appliance for correcting a set of teeth.

### BACKGROUND

In general, a plate or a steel wire is arranged on teeth and it is supported through an orthodontic fixture to correct a set of teeth. At this time, constant tension is applied to an intended direction for correction so that the teeth become to be arranged gradually on a normal position. That is, the steel wire for orthodontics is fixed to a plate that is attached to front or rear faces of teeth for continuous correction of a dentition (a set of teeth). For this correction of the set of teeth, a certain fixture is necessary for applying tension to the set of teeth to be corrected.

Meanwhile, according to a prior art, a fixture for orthodontics has been used, in which a predetermined fixing plate is arranged on a palate (a roof of the mouth differentiating an oral cavity and a nasal cavity), and a steel wire is connected to plates attached to the teeth to be corrected and then the steel wire is connected to the fixing plate by using a spring or rubber wire to apply tension. Specially, the fixing plate is fixed to a roof of the mouth through skin incision wherein since its close contact area with the roof of the mouth is much large, skin tissue of a palate (that is, mucous membrane of palate) is incised to expose a cortical bone and the fixing plate is fixed to the cortical bone and a spongy bone by using a screw, and then the incised skin tissue is sutured not to be opened by using medical thread.

In the fixing plate for a palate as described above, when the fixing plate is fixed to a roof of the mouth without incising mucous membrane of palate, necrosis of skin tissue is caused. Accordingly, even though it is inconvenient and complicated, the plate has to be fixed inevitably to a palate through skin incision operation.

### BRIEF DESCRIPTION OF THE DRAWINGS

FIG. 1 is a plan view of a palate fixture according to an embodiment.

FIG. 2 is a cross-sectional view of a palate fixture, taken in line A-A′ of FIG. 1, according to an embodiment.

FIG. 3 is a front view of a palate fixture, shown in a side direction in FIG. 1, according to an embodiment.

FIG. 4 is a partly exploded view of a plate fixture, showing a ring in FIG. 1, according to an embodiment.

FIG. 5 is a view of a use of a palate fixture in plan view according to an embodiment.

FIG. 6 is a cross-sectional view of a palate on which a palate fixture is installed, taken in line I-I′ in FIG. 5, according to an embodiment.

### DETAILED DESCRIPTION

Embodiments will be described below in detail with reference to the accompanying drawings. Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

Hereinafter, embodiments including a palate fixture for orthodontics will be described in detail, referring the accompanying drawings.

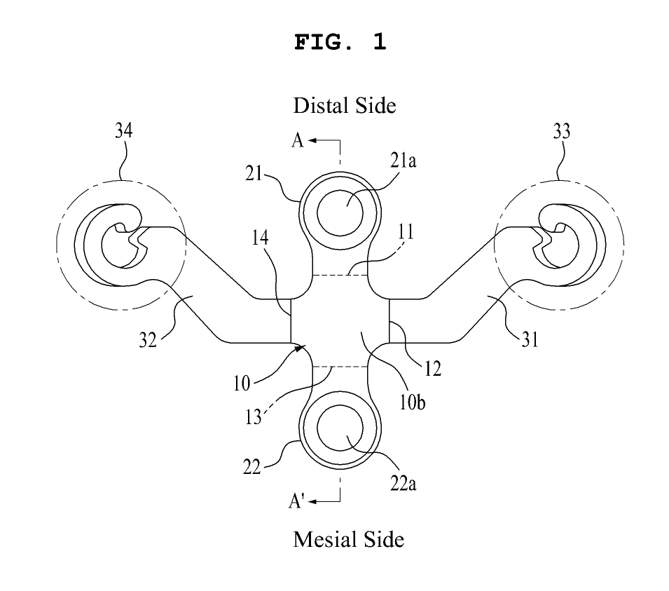

Referring to FIGS. 1 to 4, a structure and a shape of the palate fixture for orthodontics according to various embodiments are described. First, as shown in FIG. 1, the palate fixture may include a base portion 10, a pair of fixing pieces 21, 22 and a pair of ring pieces 31, 32. Here, the base portion 10 includes at least four sides, that is, a first side 11, a second side 12, a third side 13 and a fourth side 14, and an oral inner surface 10a directed to a roof of the mouth of a person to be operated and a palate surface 10b directed to inside of mouth. For example, the base portion may be a thin plate form.

Further, the fixing pieces 21 and 22 may be coupled to the base portion 10 at two corresponding sides that face each other (for example, a first side 11 and a third side 13) and extend from the base portion 10. Here, the description of fixing pieces 21, 22 that extend from the base portion 10 can, but need not necessarily mean that the fixing pieces are formed integrally with the base portion 10. For example, the fixing pieces 21 and 22 can be fabricated separately and then connected and fixed to corresponding sides of the base portion 10. In an embodiment, the fixing pieces 21 and 22 are formed on opposite sides of the base portion 10. That is, one is directed toward a distal side (a throat side when viewing a roof of the mouth) and the other is directed toward a mesial side (a tooth side at front part when viewing a roof of the mouth), leaving the base portion 10 therebetween so that a strong fixing force can be applied to induce a rear movement of an incisor tooth and a tongue side movement of a molar tooth.

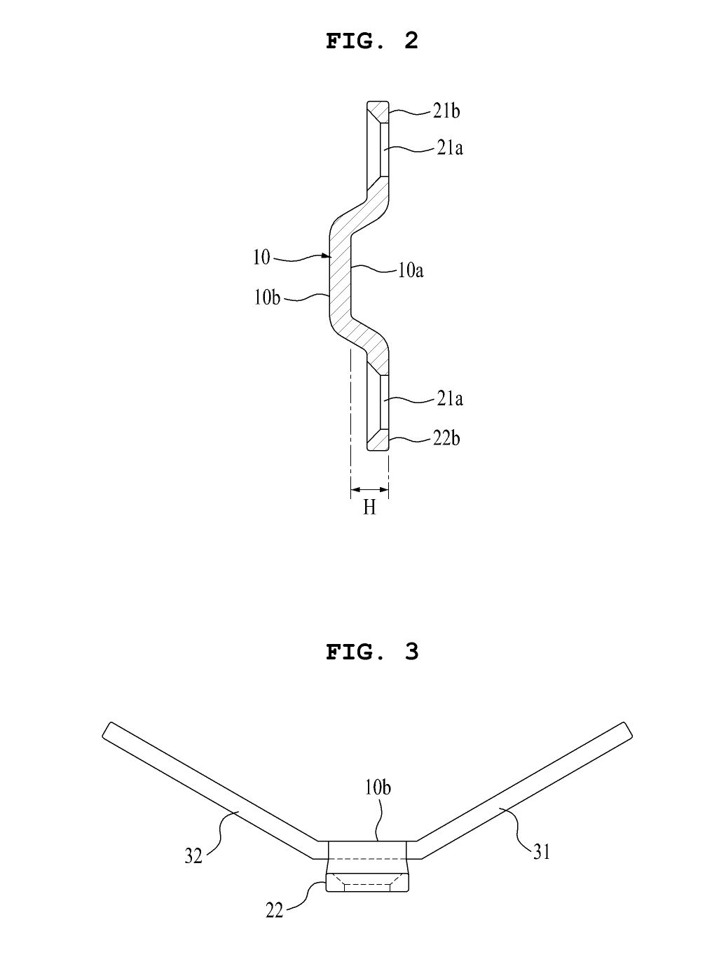

Further, the fixing pieces 21 and 22 are offset from the base portion 10 and extend from the palate surface 10a. In other words, the fixing pieces 21 and 22 are not formed on the same plane as the base portion 10. As a result, the base portion 10 is offset from a roof of the mouth of a person having the palate fixture. Here, screw holes 21a and 22a into which screws (not shown) are inserted are formed at ends of the corresponding fixing pieces 21 and 22. The fixing pieces 21 and 22 are offset from the base portion 10 and thus, when installed, only the bottom surfaces 21b and 22b are in close contact with a roof of the mouth so that an area to which the palate fixture is fixed can be minimized. For example, the bottom surfaces 21b and 22b of the fixing pieces 21 and 22 can be attached without incising and peeling off the skin tissue on the palate, even when a dimension of a fixing piece, such as a diameter, is about 4 mm. Specially, as shown in FIG. 2, a distance (that is, step height) “H” between an imaginary plane extended from the palate surface 10a of the base portion 10 and the bottom surfaces 21b and 22b of the fixing pieces 21 and 22 which are to be in close contact with the palate may be at least about 1 mm. Through this configuration, the base portion 10 may not be in close contact with the mucous membrane of the palate. Thus, a chance of necrosis of skin tissue caused from close contact of the palate fixture can be reduced if not eliminated, even when skin incision/peeling off and suturing are not performed.

In addition, a pair of ring pieces 31 and 32 may be coupled to the base portion 10 at two corresponding sides that face each other (for example, a second side 12 and a fourth side 14) and extend from the base portion 10. Here, the description of ring pieces 31 and 32 that extend from the base portion 10 can, but need not necessarily mean that the ring pieces are formed integrally with the base portion 10. For example, the fixing pieces can be fabricated separately and then connected and fixed to a corresponding side of the base portion 10. Further, as shown in FIG. 3, the ring pieces 31 and 32 may be sloped toward the oral inner surface 10b.

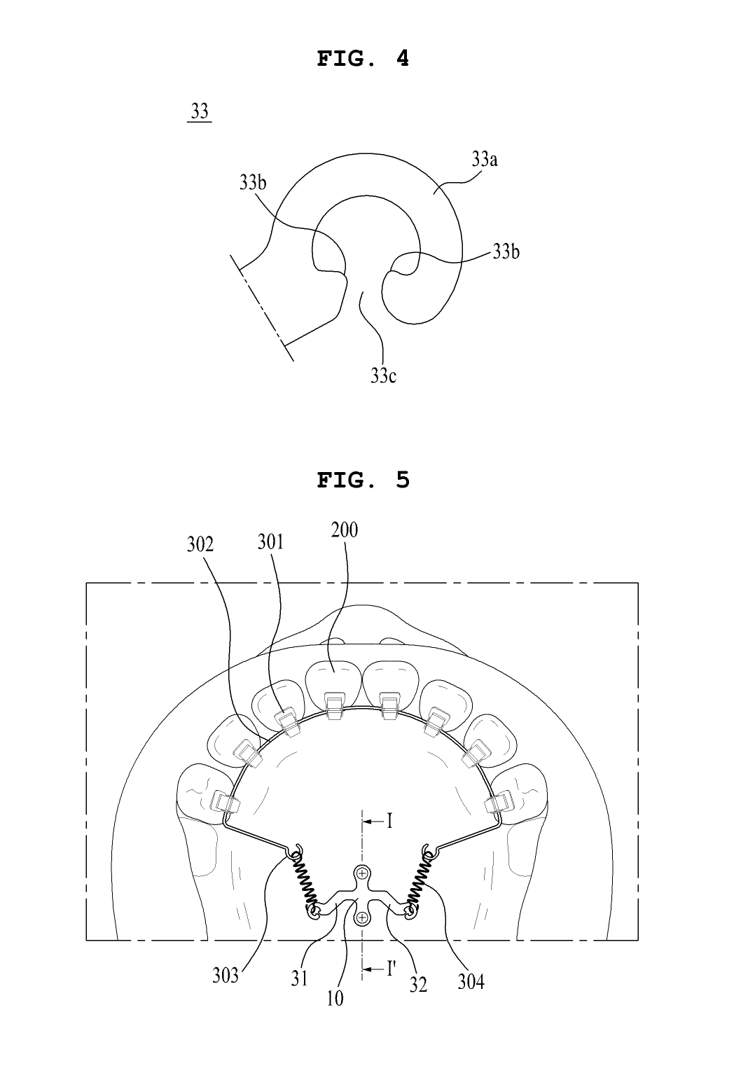

Furthermore, first and second ring portions 33 and 34 are formed on ends of the corresponding ring pieces 31 and 32. The ring pieces 31 and 32 are configured such that rubber wire, springs, or the like for orthodontics can be attached. For example, as shown in FIG. 4, the first ring portion 33 may include an opening 33c, a main ring portion 33a formed by opening the opening in a distal direction, and a pair of catching portions 33b projecting toward an inner side of the ring portion 33a from both sides of the opening 33c. The second ring portion 34 can have a similar configuration as the first ring portion 33, and thus detailed description thereof is omitted. Here, a ring formed on one end of the rubber wire or spring for orthodontics can be caught over a ring formed on the main ring portion 33a. The catching portions 33b allows the ring formed on one end of the rubber wing or spring for orthodontics not to be departed easily.

Specially, when the opening 33c is disposed in a distal direction, that is, it is directed in substantially the same direction as the first fixing piece 21, the rubber wire or spring for orthodontics may not be detached easily even when the palate fixture is used as an anchor to induce a tongue side movement of a molar tooth. Further, when the respective ring pieces 33 and 34 are sloped in distal direction from the base portion 10, the palate fixture can be used more efficiently as an anchor to induce a tongue side movement of a molar tooth.

Meanwhile, the palate fixture according to an embodiment may be made of soft material so that an operator can adjust a sloping angle of the ring piece to a desired angle. For example, the palate fixture may be made of titanium alloy wherein the titanium alloy comprises, for example, 0.20 wt % of O, 0.05 wt % of N, 0.08 wt % of C, 0.015 wt % of H, 0.40 wt % of F, 5.5˜6.75 wt % of Al, 3.5˜4.5 wt % of V, and 0.4 wt % of other inclusions. In another example, the titanium alloy comprises, about 0.20 wt % of O, about 0.05 wt % of N, about 0.08 wt % of C, about 0.015 wt % of H, about 0.40 wt % of F, about 5.5˜6.75 wt % of Al, about 3.5˜4.5 wt % of V, and about 0.4 wt % of other inclusions. Furthermore, the soft material used for the palate fixture may have at least about 825 MPa yield strength, at least about 895 MPa ultimate strength, at least about 10% elongation at 50 mm, and at least about 20% reduction per unit area.

In an embodiment, the palate fixture can provide strong fixing force for orthodontics while minimizing the area to be in close contact with the palate. Accordingly, an operation for correcting a set of teeth can be performed easily and pain to a person to be operated can be minimized using the palate fixture since incision/peeing off of mucous membrane of a palate and suturing of skin after fixing the fixture can be reduced if not eliminated. Specially, the ring piece of the palate fixture may be sloped in a distal direction and further a spring or rubber wire for orthodontics is not detached easily through a catching portion formed on the respective ring portion, and thus the palate fixture can be used as an anchor for orthodontics for not only a rear movement of an incisor tooth but also a tongue side movement of a molar tooth.

For example, as shown in FIG. 5, for correcting a set of incisor teeth 200, a plate 301 is attached to the respective teeth 200 and one end of a spring 304 is fastened to a ring 303 formed on one end of a steel wire 302 connecting the plates 301. Further, the other end of the spring 304 is fastened to the ring portions 33 and 34 provided on the ring pieces 31 and 32 of the palate fixture. The palate fixture is fixed to a palate and is exposed to oral cavity. Although a spring 304 has been illustrated a rubber wire, or the like can be used.

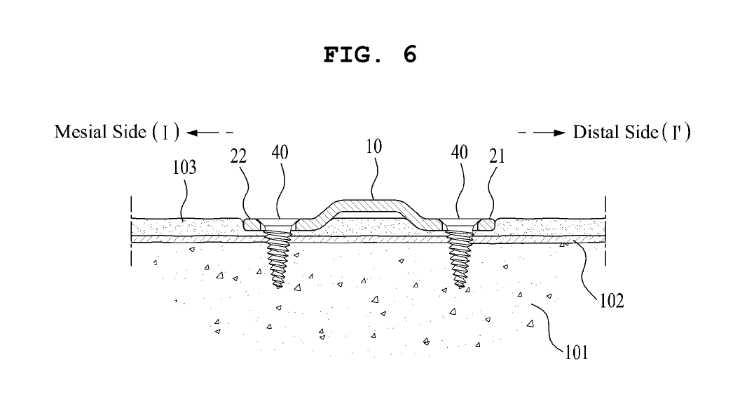

Specially, as shown in FIG. 6, a screw 40 for fixing the fixing pieces 21 and 22 of a palate fixture is screwed to a cotical bone 102 and a spongy bone 101. Here, since the diameters of the bottom surfaces in a circular shape of the fixing pieces 21 and 22, with which the palate is in close contact, are about 4 mm, a similar amount of the mucous membrane can be removed while not incising/peeling off a larger portion of the mucous membrane of the palate. That is, even though a part of a mucous membrane of a palate is removed for the screw 40 to pass through when the fixing pieces 21 and 22 are fixed to the cortical bone 102 and the spongy bone 101, an area of the removed mucous membrane is so small that suturing the skin tissue is not necessary. In addition, since the mucous membrane of a palate is not to be pushed by the base portion 10, necrosis of the skin under the base portion 10 can be reduced if not eliminated.

An embodiment includes an orthodontic appliance for correcting a set of teeth.

In an embodiment the palate fixture for orthodontics is configured to minimize an area to be in close contact with a roof of the mouth and thus it can be used as an anchor for orthodontics while it does not need to incise/peel off a larger portion of the mucous membrane of a palate around a roof of a mouth of and suture the incised skin tissue.

Further, in the palate fixture for orthodontics according to an embodiment, the sloping angles of a pair of ring pieces extended to both sides of the base portion can be adjusted so that the palate fixture can be used as an anchor for orthodontics for inducing the rear movement of an incisor tooth and the tongue side movement of a molar tooth.

In embodiment, in the palate fixture for orthodontics, the ring portion formed on the ring piece is configured such that a spring or rubber wire that is caught over the ring portion is not detached easily and thus the palate fixture can apply substantially stable tension to the teeth to be corrected when it is used as an anchor for orthodontics to induce a rear movement of an incisor tooth and a tongue side movement of a molar tooth.

The palate fixture for orthodontics according to an embodiment is configured to minimize an area to be in close contact with a roof of the mouth and thus it can be used as a certain fixture for orthodontics while it does not need to incise/peel off the mucous membrane of a palate around a roof of a mouth of and suture the incised skin tissue.

Further, in the palate fixture for orthodontics according to an embodiment, the sloping angles of a pair of ring pieces extended to both sides of the base portion can be adjusted so that the palate fixture can be used as a fixture for orthodontics with respect to the rear movement of incisor tooth and the tongue side movement of molar tooth.

Specially, in the palate fixture for orthodontics according to an embodiment, the ring portion formed on the ring piece is configured such that a spring or rubber wire that is caught over the ring portion is not departed easily and thus the palate fixture can apply stable tension to the teeth to be corrected when it is used as a fixture for orthodontics with respect to a rear movement of an incisor tooth and a tongue side movement of a molar tooth.

An embodiment includes a palate fixture for orthodontics including a base portion having at least four sides, a palate surface, and an oral inner surface; a pair of fixing pieces, each fixing piece extending from a side of the base portion that is opposite the other, and offset from the base portion; and a pair of ring pieces, each ring piece extending from a side of the base portion that is opposite the other, and sloped toward the oral inner surface.

In another embodiment, a screw hole is formed on respective ends of the pair of fixing pieces.

In another embodiment, a screw hole is formed on respective ends of the pair of fixing pieces.

In another embodiment, a distance between bottom surfaces of the pair of fixing pieces and an imaginary plane extending from the palate surface is at least about 1 mm.

In another embodiment, each ring piece comprises a ring portion formed on an end of the ring piece, and the ring portion includes a main ring portion, an opening facing in a distal direction, and a pair of catching portions projecting toward an inner side of the ring portion from sides of the opening.

In another embodiment, each of the ring pieces of the pair is sloped in a distal direction from the base portion.

While embodiments have been described with respect to the drawings, it will be apparent to those skilled in the art that other embodiments can include various changes and modifications may be made without departing from the spirit and scope of the invention as defined in the following

1. A palate fixture for orthodontics comprising:
a base portion having at least four sides, a palate surface, and an oral inner surface;
a pair of fixing pieces, each fixing piece extending from a side of the base portion that is opposite the other, and offset from the base portion; and
a pair of ring pieces, each ring piece extending from a side of the base portion that is opposite the other, and sloped toward the oral inner surface.

2. The palate fixture of claim 1, wherein a screw hole is formed on respective ends of the pair of fixing pieces.

3. The palate fixture of claim 2, wherein a distance between bottom surfaces of the pair of fixing pieces and an imaginary plane extending from the palate surface is at least about 1 mm.

4. The palate fixture of claim 1, wherein:
each ring piece comprises a ring portion formed on an end of the ring piece, and the ring portion includes a main ring portion, an opening facing in a distal direction, and a pair of catching portions projecting toward an inner side of the ring portion from sides of the opening.

5. The palate fixture of claim 1, wherein each of the ring pieces of the pair is sloped in a distal direction from the base portion.
